(19) United States
(12) Patent Application Publication
(10) Pub. No.: US 2017/0114826 A1
(43) Pub. Date: Apr. 27, 2017

(54) Telescopic Piston and Crankshaft Assembly

(71) Applicant: David Pienta, Reading, PA (US)

(72) Inventor: David Pienta, Reading, PA (US)

(21) Appl. No.: 14/921,340

(22) Filed: Oct. 23, 2015

(51) Int. Cl. F16C 3/18; F02F 3/28; F16C 7/06

(52) U.S. Cl. CPC F16C 3/18; F16C 7/06; F02F 3/28

(57) ABSTRACT

A telescopic piston and crankshaft assembly includes a crankshaft that has a plurality of rod journals. Each of the rod journals has a center portion and a pair of lateral portions. The center portion is offset from each of the lateral portions with respect to an axis of rotation extending through the crankshaft. The center portion leads the lateral portions when the crankshaft is rotated. A plurality of piston units is each rotatably coupled to the crankshaft. Each of the piston units has an outer section and an inner section. The outer section of each of the piston units is rotatably coupled to each of the lateral portions of an associated one of the rod journals. The inner section of the piston units is rotatably coupled to the center portion of an associated one of the rod journals. The inner section leads the outer section when the crankshaft rotates.

### BACKGROUND OF THE DISCLOSURE

### Field of the Disclosure

The disclosure relates to piston and crankshaft devices and more particularly pertains to a new piston and crankshaft device for increasing an efficiency of an internal combustion engine.

### SUMMARY OF THE DISCLOSURE

An embodiment of the disclosure meets the needs presented above by generally comprising a crankshaft that may be rotatably coupled to an engine block. The crankshaft has a plurality of rod journals and each of the rod journals has a center portion and a pair of lateral portions. The center portion is offset from each of the lateral portions with respect to an axis of rotation extending through the crankshaft such that the center portion leads the lateral portions when the crankshaft is rotated. A plurality of piston units is provided and each of the piston units is rotatably coupled to the crankshaft. Each of the piston units is positioned on an associated one of the rod journals and each of the piston units has an outer section and an inner section. The outer section of each of the piston units is rotatably coupled to each of the lateral portions of an associated one of the rod journals. The inner section of each of the piston units is rotatably coupled to the center portion of an associated one of the rod journals such that the inner section leads the outer section when the crankshaft rotates.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a piston unit of a telescopic piston and crankshaft assembly according to an embodiment of the disclosure.

FIG. 2 is a front view of the piston unit of an embodiment of the disclosure.

FIG. 3 is a cross sectional view taken along line 3-3 of FIG. 2 of the piston unit of an embodiment of the disclosure.

FIG. 4 is a perspective in-use view of an embodiment of the disclosure.

FIG. 5 is a perspective view of the piston unit coupled to a crankshaft of an embodiment of the disclosure.

FIG. 6 is a right side view of the crankshaft of an embodiment of the disclosure.

FIG. 7 is a front view of the crankshaft of an embodiment of the disclosure.

### DESCRIPTION OF THE PREFERRED EMBODIMENT

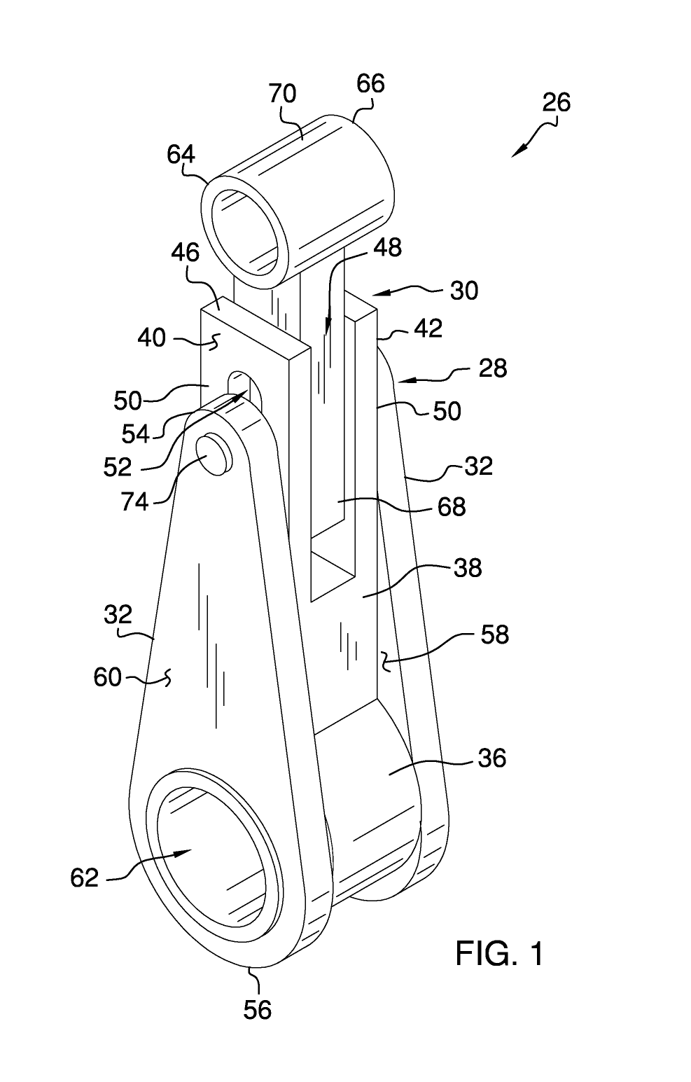

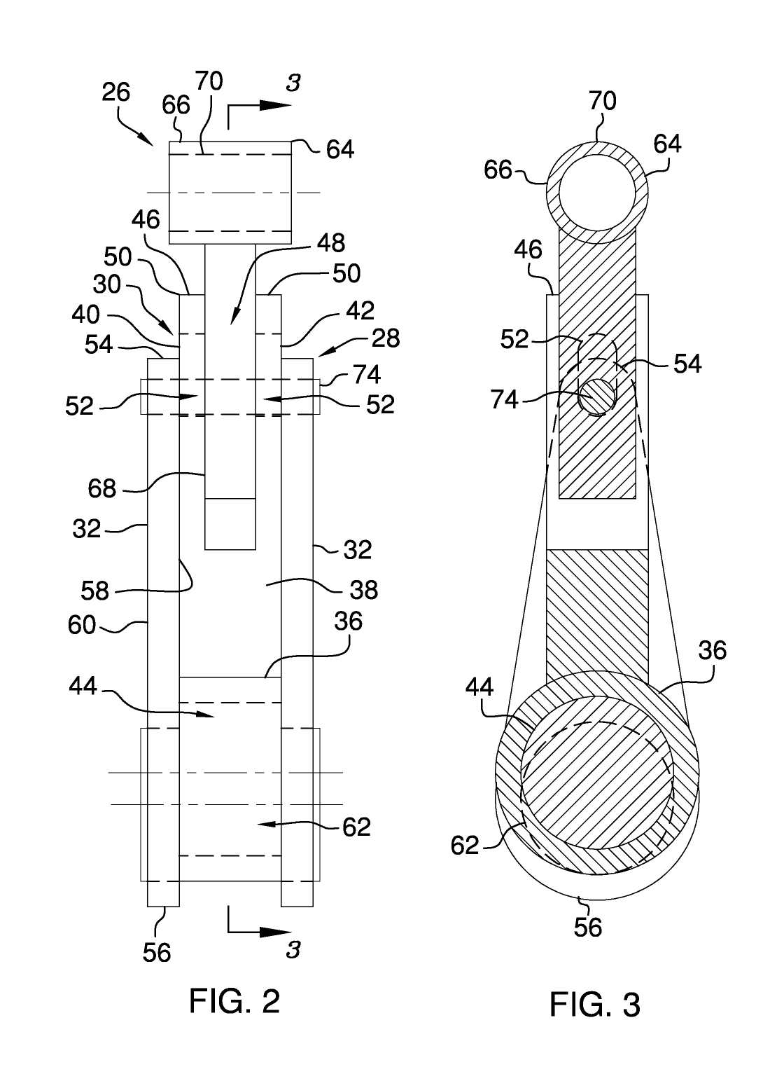

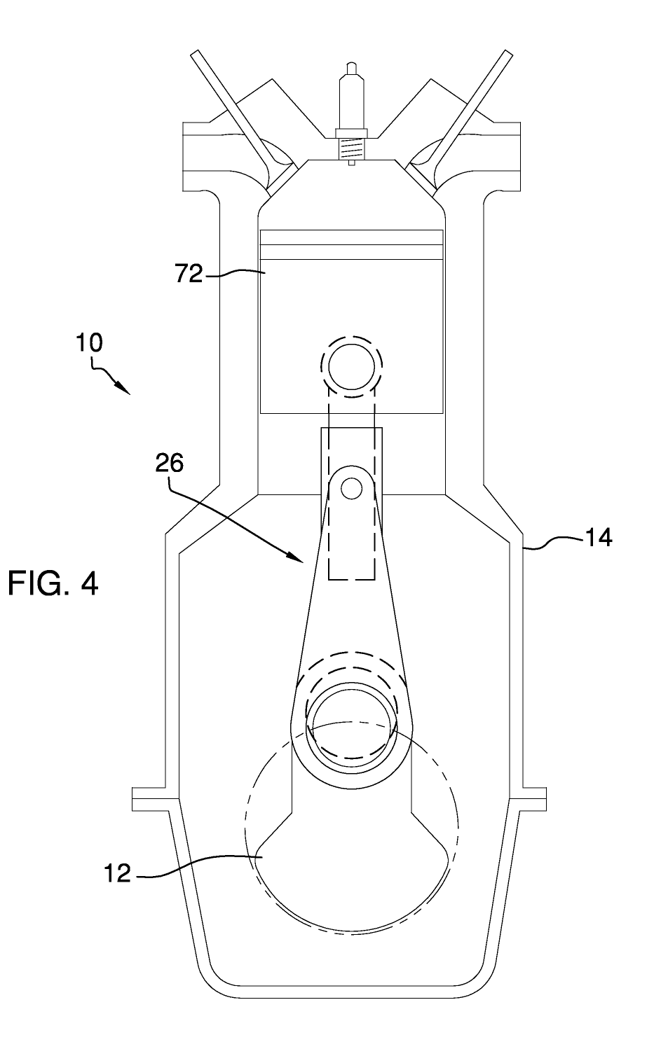

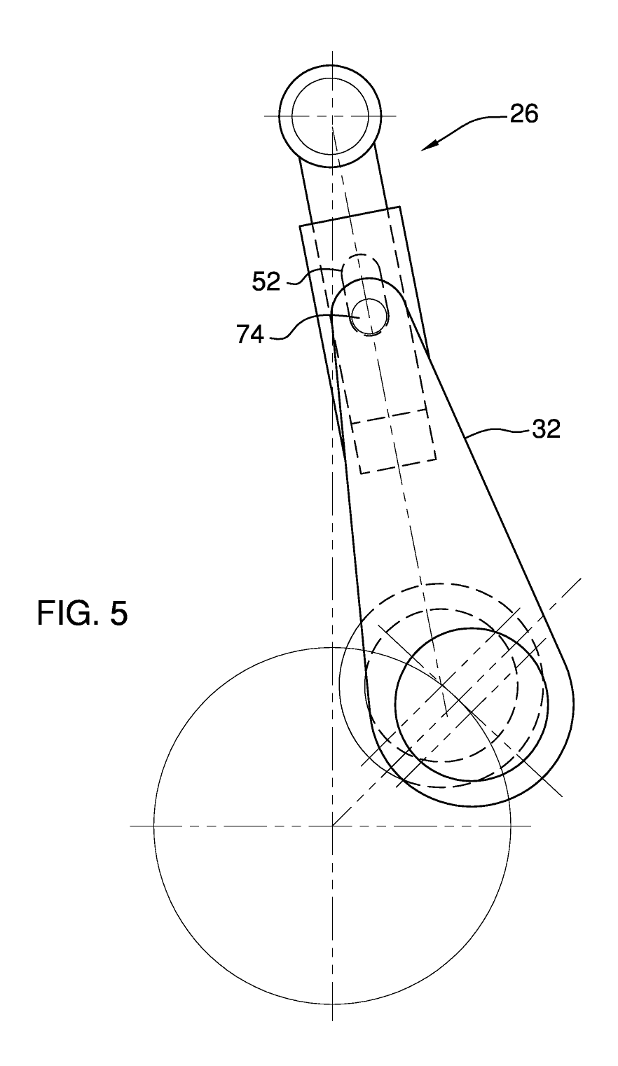

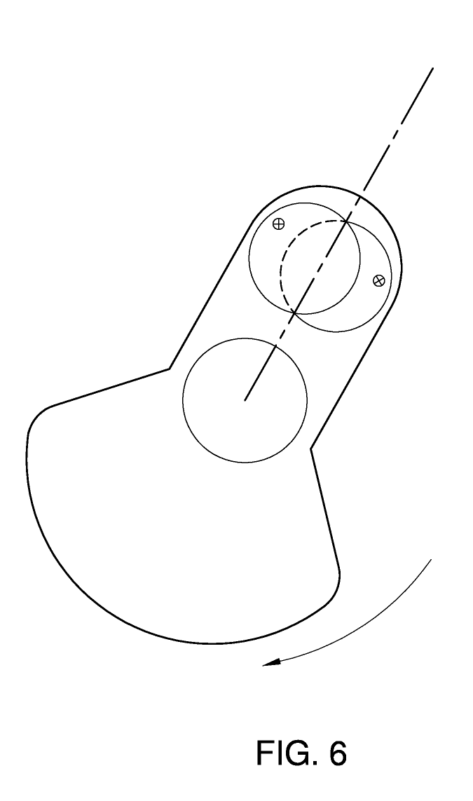

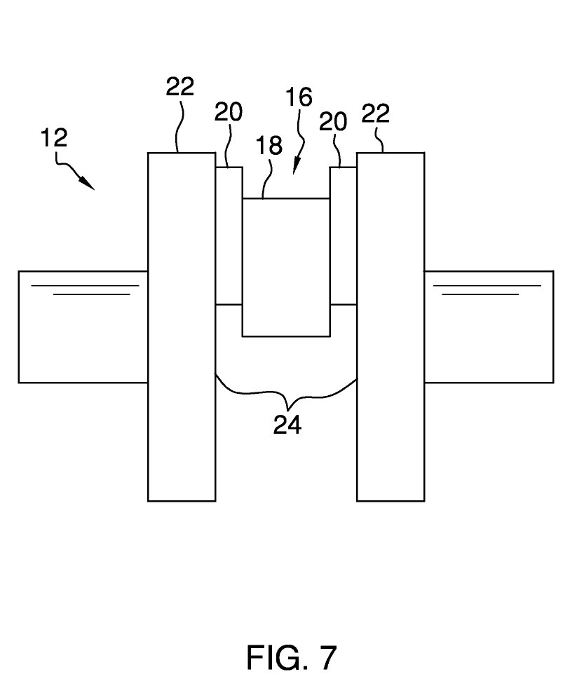

With reference now to the drawings, and in particular to FIGS. 1 through 7 thereof, a new piston and crankshaft device embodying the principles and concepts of an embodiment of the disclosure and generally designated by the reference numeral 10 will be described.

As best illustrated in FIGS. 1 through 7, the telescopic piston and crankshaft assembly 10 generally comprises a crankshaft 12 that may be rotatably coupled to an engine block 14. The crankshaft 12 has a plurality of rod journals 16 and each of the rod journals 16 has a center portion 18 and a pair of lateral portions 20. The center portion 18 is offset from each of the lateral portions 20 with respect to an axis of rotation extending through the crankshaft 12. Thus, the center portion 18 leads the lateral portions 20 when the crankshaft 12 is rotated. The crankshaft 12 may be a crankshaft for a four stroke internal combustion engine or the like and the engine block 14 may comprise a four stroke internal combustion engine block.

The crankshaft 12 has a plurality of sets of webs 22 and each of the webs 22 has an inwardly facing surface 24. Each of the rod journals 16 extends between the inwardly facing surface 24 of an associated set of webs 22. Each of the lateral portions 20 is coupled to the inwardly facing surface 24 of the associated set of webs 22 and the center portion 18 extends between the lateral portions 20. The center portion 18 of an associated one of the rod journals 16 leads each of the lateral portions 20 of the associated rod journal 16 in rotation with respect to the crankshaft 12

A plurality of piston units 26 is provided and each of the piston units 26 is rotatably coupled to the crankshaft 12. Each of the piston units 26 is positioned on an associated one of the rod journals 16. Each of the piston units 26 has an outer section 28 and an inner section 30. The outer section 28 of each of the piston units 26 is rotatably coupled to each of the lateral portions 20 of an associated one of the rod journals 16. The inner section 30 of each of the piston units 26 is rotatably coupled to the center portion 18 of an associated one of the rod journals 16 such that the inner section 30 leads the outer section 28 when the crankshaft 12 rotates. The outer section 28 is retarded with respect to the inner section 30 on a combustion stroke and an intake stroke of the crankshaft 12. The outer section 28 is advanced with respect to the inner section 30 on a compression stroke and an exhaust stroke of the crankshaft 12.

The outer section 28 of each of the piston units 26 includes a pair of arms 32 and the inner section 30 of each of the piston units 26 comprises a first connecting rod 34. The first connecting rod 34 has a round portion 36, an elongated portion 38, a first surface 40 and a second surface 42. The elongated portion 38 extends upwardly from the round portion 36 and the round portion 36 has an opening 44 extending through the first surface 40 and the second surface 42. The opening 44 in the round portion 36 insertably receives the center portion 18 of the associated rod journal 16.

The elongated portion 38 has a top end 46. The top end 46 has a channel 48 extending downwardly toward the round portion 36 to define a pair of tabs 50. Each of the tabs 50 has a slot 52 extending therethrough. The slot 52 on each of the tabs 50 is positioned proximate the top end 46. The slot 52 on each of the tabs 50 extends longitudinally along the tabs 50.

Each of the arms 32 of the outer section 28 has a first end 54, a second end 56, an inwardly facing surface 58 and an outwardly facing surface 60. Each of the arms 32 tapers between the first end 54 and the second end 56. Each of the arms 32 has an opening 62 extending through the inwardly facing surface 58 and the outwardly facing surface 60 of the arms 32. The opening 62 in each of the arms 32 is positioned adjacent to the second end 56 of an associated one of the arms 32. The opening 62 in each of the arms 32 insertably receives an associated one of the lateral portions 20 of an associated one of the rod journals 16 such that each of the arms 32 is spaced apart from each other. Thus, the first connecting rod 34 is positioned between the pair of arms 32.

The outer section 28 further includes a second connecting rod 64. The second connecting rod 64 has a piston coupler 66 and a connection section 68. The piston coupler 66 has an outer wall 70 and the outer wall 70 is curved, giving the piston coupler 66 a tubular shape. The connection section 68 extends downwardly from the outer wall 70 of the piston coupler 66 and the connection section 68 is elongated. The connection section 68 is positioned in the channel 48 such that the piston coupler 66 is spaced from the top end 46 of the first connecting rod 34. The piston coupler 66 has a piston 72 coupled thereto. The piston 72 may comprise an internal combustion engine piston or the like.

A pin 74 is provided the pin 74 is extends through the arms 32. The pin 74 is positioned proximate the first end 54 of the arms 32. The pin 74 extends through the slot 52 in each of the tabs 50. The pin 74 engages the connection section 68 of the second connecting rod 64 such that the second connecting rod 64 is coupled to the pair of arms 32.

The piston coupler 66 is urged upwardly with respect to the top end 46 on the combustion stroke. Thus, the piston 72 is inhibited from accelerating beyond a speed of expanding gasses in the internal combustion engine during the combustion stroke. The rotational speed of the crankshaft 12 is not reduced while the stroke speed of the piston 72 is reduced during the combustion stroke. The piston 72 is continually exposed to a force of the expanding gasses during the combustion stroke thereby facilitating all of the force generated by the expanding gases to be transferred into the crankshaft 12. Thus, an efficiency of the internal combustion engine is increased.

In use, the crankshaft 12 is retrofitted into the engine block 14 and each of the piston units 26 is rotatably coupled to the associated one of the rod journals 16. The piston 72 is retarded in speed with respect to the inner section 30 of the associated piston unit 26 during the combustion stroke. Thus, the piston 72 is inhibited from accelerating beyond the speed of the expanding gasses in the internal combustion engine during the combustion stroke. The piston 72 is exposed to the force of the expanding gasses during the entire duration of the combustion stroke. Thus, the piston 72 efficiently transfers the force of the expanding gasses to the crankshaft 12 thereby increasing an efficiency of the internal combustion engine.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A telescopic piston and crankshaft assembly comprising:
a crankshaft being configured to be rotatably coupled to an engine block, said crankshaft having a plurality of rod journals, each of said rod journals having a center portion and a pair of lateral portions, said center portion being offset from each of said lateral portions with respect to an axis of rotation extending through said crankshaft such that said center portion leads said lateral portions when said crankshaft is rotated; and
a plurality of piston units, each of said piston units being rotatably coupled to said crankshaft, each of said piston units being positioned on an associated one of said rod journals, each of said piston units having an outer section and an inner section, said outer section of each of said piston units being rotatably coupled to each of said lateral portions of an associated one of said rod journals, said inner section of each of said piston units being rotatably coupled to said center portion of an associated one of said rod journals such that said inner section leads said outer section when said crankshaft rotates, said outer section being retarded with respect to said inner section on a combustion stroke and an intake stroke of said crankshaft wherein each of said piston units is configured to increase an efficiency of an internal combustion engine, said outer section being advanced with respect to said inner section on a compression stroke and an exhaust stroke of said crankshaft.

2. The assembly according to claim 1, wherein said crankshaft had a plurality of sets of webs, each of said webs having an inwardly facing surface, each of said rod journals extending between said inwardly facing surface of an associated set of webs, each of said lateral portions being coupled to said inwardly facing surface of said associated set of webs.

3. The assembly according to claim 2, wherein said center portion extends between said lateral portions, said center portion of an associated one of said rod journals leads each of said lateral portions of said associated rod journal in rotation with respect to said crankshaft.

4. The assembly according to claim 1, wherein:
said outer section of each of said piston units includes a pair of arms; and
said inner section of each of said piston units comprising a first connecting rod having a round portion, an elongated portion, a first surface and a second surface, said elongated portion extending upwardly from said round portion, said round portion having an opening extending through said first surface and said second surface, said opening in said round portion insertably receiving said center portion of said associated rod journal such that said first connecting rod is positioned between said pair of arms.

5. The assembly according to claim 4, wherein said elongated portion has a top end, said top end having a channel extending downwardly toward said round portion to define a pair of tabs.

6. The assembly according to claim 5, wherein each of said tabs has a slot extending therethrough, said slot on each of said tabs being positioned proximate said top end.

7. The assembly according to claim 1, wherein said outer section of each of said piston units comprises a pair of arms, each of said arms having a first end, a second end, an inwardly facing surface and an outwardly facing surface, each of said arms tapering between said first end and said second end.

8. The assembly according to claim 7, wherein each of said arms has an opening extending through said inwardly facing surface and said outwardly facing surface of said arms, said opening in each of said arms being positioned adjacent to said second end of an associated one of said arms, said opening in each of said arms insertably receiving an associated one of said lateral portions of an associated one of said rod journals such that each of said arms is spaced apart from each other.

9. The assembly according to claim 1, wherein said outer section of each of said piston units further comprises a second connecting rod having a piston coupler and a connection section, said connection section extending downwardly from said piston coupler, said connection section being elongated.

10. The assembly according to claim 9, wherein:
said inner section of each of said piston units comprises a first connecting rod, said first connecting rod having a top end and a channel; and
said connection section being positioned in said channel such that said piston coupler is spaced from said top end of said first connecting rod, said piston coupler being configured to have a piston being coupled thereto.

11. The assembly according to claim 7, further comprising a pin, said pin extending through said arms, said pin being positioned proximate said first end of said arms.

12. The assembly according to claim 11, wherein:
said inner section of each of said piston units includes a pair of tabs, each of aid tabs having a slot;
said outer section of each of said piston units includes a second connecting rod, said second connecting rod having a connection section and a piston coupler; and
said pin extends through said slot in each of said tabs, said pin engaging said connection section of said second connecting rod such that said second connecting rod is coupled to said pair of arms.

13. The assembly according to claim 12, wherein said piston coupler is urged upwardly with respect to said top end on said combustion stroke wherein said piston coupler is configured to be inhibited from accelerating beyond a speed of expanding gasses in the internal combustion engine thereby increasing an efficiency of the internal combustion engine.

14. A telescopic piston and crankshaft assembly comprising:
a crankshaft being configured to be rotatably coupled to an engine block, said crankshaft having a plurality of rod journals, each of said rod journals having a center portion and a pair of lateral portions, said center portion being offset from each of said lateral portions with respect to an axis of rotation extending through said crankshaft such that said center portion leads said lateral portions when said crankshaft is rotated, said crankshaft having a plurality of sets of webs, each of said webs having an inwardly facing surface, each of said rod journals extending between said inwardly facing surface of an associated set of webs, each of said lateral portions being coupled to said inwardly facing surface of said associated set of webs, said center portion extending between said lateral portions, said center portion of an associated one of said rod journals leads each of said lateral portions of said associated rod journal in rotation with respect to said crankshaft; and
a plurality of piston units, each of said piston units being rotatably coupled to said crankshaft, each of said piston units being positioned on an associated one of said rod journals, each of said piston units having an outer section and an inner section, said outer section of each of said piston units being rotatably coupled to each of said lateral portions of an associated one of said rod journals, said inner section of each of said piston units being rotatably coupled to said center portion of an associated one of said rod journals such that said inner section leads said outer section when said crankshaft rotates, said outer section being retarded with respect to said inner section on a combustion stroke and an intake stroke of said crankshaft wherein each of said piston units is configured to increase an efficiency of an internal combustion engine, said outer section being advanced with respect to said inner section on a compression stroke and an exhaust stroke of said crankshaft, said outer section of each of said piston units including a pair of arms, said inner section of each of said piston units comprising a first connecting rod having a round portion, an elongated portion, a first surface and a second surface, said elongated portion extending upwardly from said round portion, said round portion having an opening extending through said first surface and said second surface, said opening in said round portion insertably receiving said center portion of said associated rod journal such that said first connecting rod is positioned between said pair of arms, said elongated portion having a top end, said top end having a channel extending downwardly toward said round portion to define a pair of tabs, each of said tabs having a slot extending therethrough, said slot on each of said tabs being positioned proximate said top end;
said outer section of each of said piston units comprising:
each of said arms having a first end, a second end, an inwardly facing surface and an outwardly facing surface, each of said arms tapering between said first end and said second end, each of said arms having an opening extending through said inwardly facing surface and said outwardly facing surface of said arms, said opening in each of said arms being positioned adjacent to said second end of an associated one of said arms, said opening in each of said arms insertably receiving an associated one of said lateral portions of an associated one of said rod journals such that each of said arms is spaced apart from each other,
a second connecting rod having a piston coupler and a connection section, said connection section extending downwardly from said piston coupler, said connection section being elongated, said connection section being positioned in said channel such that said piston coupler is spaced from said top end of said first connecting rod, said piston coupler being configured to have a piston being coupled thereto, and
a pin extending through each of said arms, said pin being positioned proximate said first end of said arms, said pin extending through said slot in each of said tabs, said pin engaging said connection section of said second connecting rod such that said second connecting rod is coupled to said pair of arms, said piston coupler being urged upwardly with respect to said top end on said combustion stroke wherein said piston coupler is configured to be inhibited from accelerating beyond a speed of expanding gasses in the internal combustion engine thereby increasing an efficiency of the internal combustion engine.
